(19) United States
(12) Patent Application Publication
(10) Pub. No.: US 2026/0295845 A1
(43) Pub. Date: Oct. 1, 2026

(54) ROBOT SYSTEM

(71) Applicants: NACHI-FUJIKOSHI CORP., Tokyo (JP); THE UNIVERSITY OF TOKYO, Tokyo (JP)

(72) Inventors: Hiroki Murakami, Toyama (JP); Akio Yamamoto, Tokyo (JP)

(21) Appl. No.: 19/571,949

(22) Filed: Mar. 19, 2026

(30) Foreign Application Priority Data
Mar. 27, 2025 (JP) 2025-053221

(51) Int. Cl. B25J 9/16; B25J 9/06; B25J 19/02

(52) U.S. Cl. CPC B25J 9/1694; B25J 9/06; B25J 19/02

(57) ABSTRACT

A robot system includes: a robot including arms; sensors disposed in the respective arms and configured to detect presence of an object; and a robot control apparatus. The robot control apparatus includes a memory in which a program is stored, and a processor programmed to execute the program stored in the memory. The processor is programmed to control the robot to perform a preprogrammed operation, to set correspondence information by associating each of intervals of the preprogrammed operation with reference information on the sensed values that are output from the sensors due to the preprogrammed operation, and to control, after the correspondence information has been set, the robot to perform the preprogrammed operation and perform a stop control or a deceleration control of the robot by comparing the sensed values that are output from the sensors with the reference information on the sensed values related to the intervals.

### RELATED APPLICATIONS

The present application claims priority under 35 U.S.C. §119 to Japanese Patent Application No. 2025-053221 filed on Mar. 27, 2025, the entire content of which is incorporated herein by reference.

### BACKGROUND OF THE INVENTION

### 1. Field of the Invention

The present invention relates to a robot system.

### 2. Description of the Related Art

This section merely provides a description of background technology in the field in which the present invention is embodied, and may not necessarily describe prior art in the field.

Humans and robots may work collaboratively on a workpiece in the same environment. Such robots may incorporate noncontact sensors for detecting the presence of objects nearby.

For example, Japanese Patent No. 6988531 teaches operating a robot in a state where no moving bodies are allowed to enter a space in which the robot moves, associating tool center position (TCP) coordinates with an output value of a noncontact sensor, and performing a stop control on the robot with the output value as a reference output value.

### SUMMARY OF THE INVENTION

However, the noncontact sensor in Japanese Patent No. 6988531 is disposed only at the distal end portion of the robot, and objects approaching the robot arm are difficult to detect. Furthermore, Japanese Patent No. 6988531 assumes a case predicated on the robot being equipped with a single noncontact sensor. While effect of the surrounding environment on the robot can be reduced, the mutual effects of noncontact sensors due to changes in the posture of the robot during operation are not taken into consideration. There is therefore room for improvement in the accuracy of object detection by the noncontact sensor. There is also potential for reduction in the computational processing load associated with object detection.

In view of the foregoing problems, one or more aspects of the present invention provide a robot system that is capable of detecting presence of objects approaching the robot arms, this robot system also exhibiting an improved accuracy in detecting presence of objects with noncontact sensors and having a reduced processing load.

To solve the foregoing problems, a robot system according to the present invention comprises: a robot including a plurality of arms; a plurality of noncontact sensors disposed in the arms and configured to detect presence of an object; and a robot control apparatus programmed to control operation of the robot based on sensed values that are output from the noncontact sensors. The robot control apparatus includes a memory in which a program is stored, and a processor programmed to execute the program stored in the memory. The processor is programmed to control the robot to perform a preprogrammed operation, to set correspondence information by associating each of intervals of the preprogrammed operation with reference information on the sensed values that are output from the noncontact sensors due to the preprogrammed operation, and to control, after the correspondence information has been set, the robot to perform the preprogrammed operation, and to perform a stop control or a deceleration control of the robot by comparing the sensed values that are output from the noncontact sensors with the reference information on the sensed values related to the intervals.

In the robot system, the processor is programmed to set thresholds corresponding to the intervals as the reference information by adding a margin to maximum values of the sensed values that are output from the noncontact sensors in the intervals during operation. If one of the sensed values corresponding to one of the intervals reaches or exceeds the threshold corresponding to the interval, the processor is programmed to perform the stop control or the deceleration control.

In the robot system, the processor is configured to correct the operation of the robot performing the preprogrammed operation, and to set the thresholds corresponding to the intervals with the maximum values of the sensed values in the intervals when the robot is operated under each of a plurality of correction patterns as the maximum values.

In the robot system, the correction patterns are classified into a plurality of groups. The processor is programmed to set the thresholds corresponding to the intervals and the groups with the maximum values of the sensed values in the intervals when the robot is operated under each of the correction patterns included in the groups as the maximum values and to perform the stop control or the deceleration control on the operation of the robot using the thresholds of the groups corresponding to the correction patterns.

In the robot system, the processor is programmed to identify an interval corresponding to the sensed values of the noncontact sensors in consideration of an output delay in the sensed values, and to perform the stop control or the deceleration control by comparing the sensed values with the reference information in the identified interval.

In the robot system, the processor is programmed to set the correspondence information in consideration of an output delay in the sensed values of the noncontact sensors, and to perform the stop control or the deceleration control using the set correspondence information.

According to the robot system of the present invention, the presence of objects approaching the robot arms can be detected, and an improved accuracy in detecting presence of objects with the noncontact sensors can be exhibited while the robot system has a reduced processing load.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram showing an exemplary overall configuration of a robot system according to a first embodiment of the present invention;

FIG. 2 is a diagram showing various exemplary functions implemented by the robot control apparatus of FIG. 1;

FIG. 3 is a diagram showing an exemplary operation of the robot of FIG. 1;

FIG. 4 is a diagram showing exemplary changes in sensed values when the pre-motion controller of FIG. 2 controls the robot to perform a preprogrammed operation;

FIG. 5 is a diagram showing exemplary changes in the sensed values when the main controller of FIG. 2 controls the robot to perform the preprogrammed operation;

FIG. 6 is a flowchart showing an exemplary processing procedure of the robot control apparatus of FIG. 1;

FIG. 7 is a diagram showing various exemplary functions implemented a robot control apparatus according to a second embodiment of the present invention;

FIG. 8 is a diagram showing an exemplary group classification corresponding to a plurality of correction patterns by the corrector of FIG. 7;

FIG. 9 is a diagram showing an exemplary setting of correspondence information that accommodates an output delay by a robot control apparatus according to a third embodiment of the present invention; and

FIG. 10 is a diagram showing an exemplary interval subdivision method performed by a robot control apparatus according to a modification of the present invention.

### DETAILED DESCRIPTION OF THE PREFERRED EMBODIMENTS

Embodiments of the subject matter now will be described in further detail hereinafter with reference to the attached figures. In the figures, identical or corresponding constituents are identified using the same reference numerals, and redundant description is omitted. Also, the figures are not necessarily to scale, as the size of some of the structures or portions of the figures may be exaggerated relative to other structures or portions for illustrative purposes. Further, some of the figures are schematically illustrated to facilitate understanding of the structures represented therein.

### FIRST EMBODIMENT

Initially, a first embodiment will be described.

### Overall Configuration

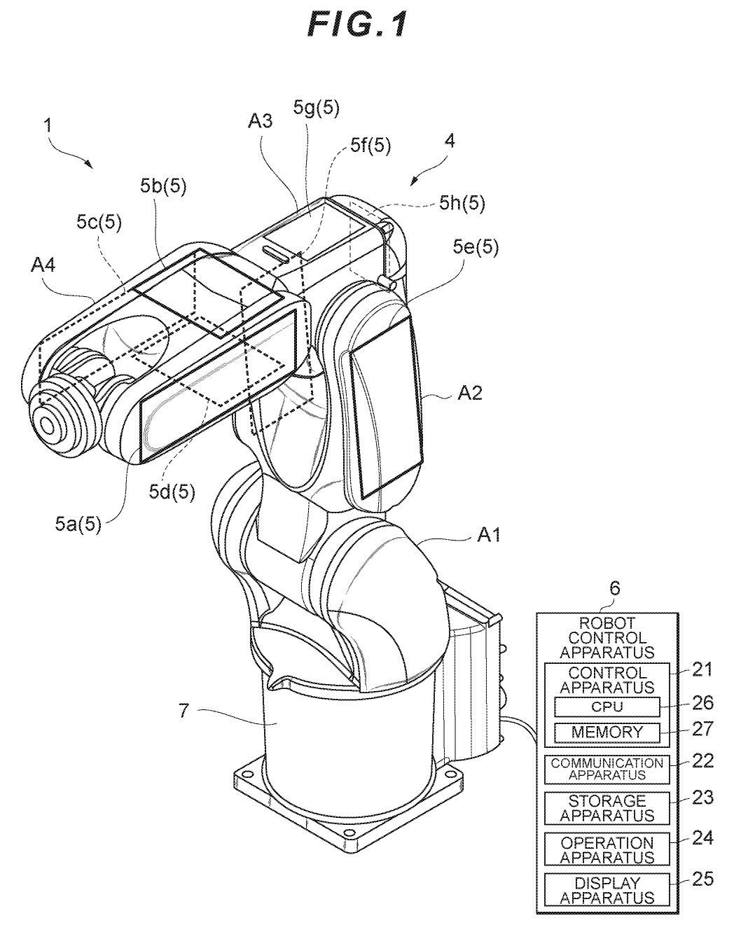

FIG. 1 is a schematic diagram showing an exemplary overall configuration of a robot system 1 according to the first embodiment of the present invention. The robot system 1 is an industrial robot that is capable of performing tasks such as machining and transporting of a workpiece. For example, the robot system 1 is a collaborative robot that is capable of performing tasks within a work space shared by human workers.

As shown in FIG. 1, the robot system 1 mainly includes a robot 4, a plurality of sensors 5, and a robot control apparatus 6.

The robot 4 is configured with a plurality of articulated arms. Specifically, the robot 4 includes a base 7, a first arm A1, a second arm A2, a third arm A3, and a fourth arm A4. The base 7 is the foundation of the robot 4. The first arm A1 is connected to the base 7 via a rotating shaft, and is rotated by a motor (not shown). Similarly to the first arm A1, the second, third, and fourth arms A2, A3, and A4 are each rotated about their respective rotating shafts by respective motors (not shown). A tool is attached to the distal end of the fourth arm A4, for example.

The sensors 5 are noncontact sensors configured to detect presence of objects such as human workers. The noncontact sensors are functional in detecting presence of objects without contact. In the present embodiment, the term "an object" is given a broad range of connotations that includes humans, workpieces, and other objects. For example, an object is a moving body that is capable of moving near the robot 4.

In the present embodiment, the sensors 5 each comprise a capacitive proximity sensor configured to output sensed values representing capacitances created between the sensors 5 and objects. The sensor 5 is not limited to capacitive one and may be a noncontact sensor of any optional detection method as long as it can detect presence of objects in a non-contact manner.

The robot 4 is equipped with a plurality of sensors 5. As an example, the robot 4 according to the present embodiment is contemplated to have the sensors 5 that includes a sensor 5a, a sensor 5b, a sensor 5c, a sensor 5d, a sensor 5e, a sensor 5f, a sensor 5g, and a sensor 5h. Each sensor 5 is disposed in an arm of the robot 4. Specifically, the sensors 5 are disposed at respective side surfaces of arms. The sensors 5a to 5d are incorporated in the fourth arm A4. The sensors 5e and 5f are incorporated in the arm A2. The sensors 5g and 5h are incorporated in the third arm A3. The sensors 5 are thus provided to the respective arms. The installation positions and the number of sensors 5 installed are not limited to a particular configuration.

The sensor 5 includes a detection electrode (not shown). For example, the detection electrode may be configured according to the outer shape of the arm. The sensor 5 generates an electric field from its detection electrode in a certain direction. Specifically, the sensor 5 generates an electric field toward circumference surrounding the robot 4. The detection electrode then creates a capacitance between itself and an object nearby. The capacitance varies as the distance changes between the detection electrode and the object. A voltage appearing at the detection electrode that reflects the created capacitance is output via an RC bridge circuit, an amplifier, and/or an analog-to-digital (A/D) converter, for example. In other words, the sensor 5 outputs the sensed value reflecting the capacitance created depending on the state of (reflecting the distance between) the detection electrode and the object. For example, the sensed values increases as the object approaches the detection electrode. As long as the detection electrode of the sensor 5 is provided to the arm, the other components of the sensor 5 do not need to be provided to the arm.

The robot control apparatus 6 is an information processing apparatus (computer) that is programmed to implement the operation control of the robot 4. In particular, the robot control apparatus 6 is programmed to implement the operation control of the robot 4 using the sensed values of the sensors 5. For example, the robot control apparatus 6 includes a control apparatus 21, a communication apparatus 22, a storage apparatus 23, an operation apparatus 24, and a display apparatus 25. The control apparatus 21 is configured to mainly include a central processing unit (CPU) 26 and a memory 27. The control apparatus 21 is programmed to implement various functional components, described below, by using the CPU 26, which is an example of a processor that is capable of executing preinstalled programs stored in the memory 27, the storge apparatus 23, or other storage circuits. The communication apparatus 22 includes a communication interface, or the like. The storage apparatus 23 includes a hard disk or the like, and stores various programs, various types of information, and the like needed for the control apparatus 21 to perform robot functions. The operation apparatus 24 is an input device configured to receive inputs. The display apparatus 25 displays various types of information. The robot control apparatus 6 may be implemented by a single information processing apparatus or a plurality of information processing apparatuses. FIG. 1 merely shows some of the essential hardware components of the robot control apparatus 6, and other components may also be included.

As described above, the sensors 5 output sensed values based on their distances to objects nearby. The sensed values may be affected by the surrounding environment, such as equipment installed in advance near the robot 4. The equipment and the like (fixtures) installed in advance in the surroundings are set up in a manner that does not interfere with the operation of the robot 4. The robot control apparatus 6 is thus configured to detect presence of objects (moving bodies and the like) other than the fixtures such as the surrounding equipment while accounting for the effect of the fixtures.

### Functional Configuration

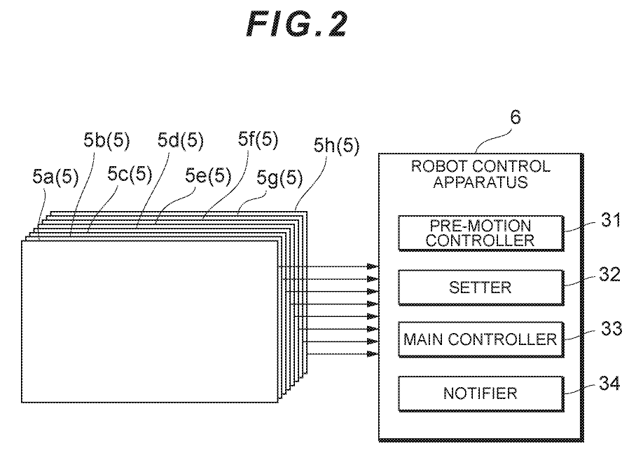

FIG. 2 is a diagram showing various exemplary functions implemented by the robot control apparatus 6. The robot control apparatus 6 includes a pre-motion controller 31, a setter 32, a main controller 33, and a notifier 34. The control apparatus 21 (the processor) is programmed to implement the respective functions, including the pre-motion controller 31, the setter 32, the main controller 33, the notifier 34, and the like, executing the programs stored in the storage apparatus 23 and the like.

The pre-motion controller 31 controls the robot 4 to perform preprogrammed operation. Specifically, the pre-motion controller 31 controls the robot 4 to perform a preprogrammed operation in a state where no objects enter (are allowed to enter) the vicinity of the robot 4. In other words, the pre-motion controller 31 controls the robot 4 to perform a preprogrammed operation in a state where no object other than the equipment and the like installed in advance near the robot 4 is present near the robot 4. The pre-motion controller 31 operates the robot 4 in a preliminary stage before operations that the main controller 33, described below, controls the robot 4 to perform. The preprogrammed operation that the preliminary operation device 31 controls the robot 4 to perform can be said to be a preparatory operation.

The preprogrammed operation is set in advance as an operation to be performed by the robot 4. For example, the preprogrammed operation is implemented by an operation program of the robot 4.

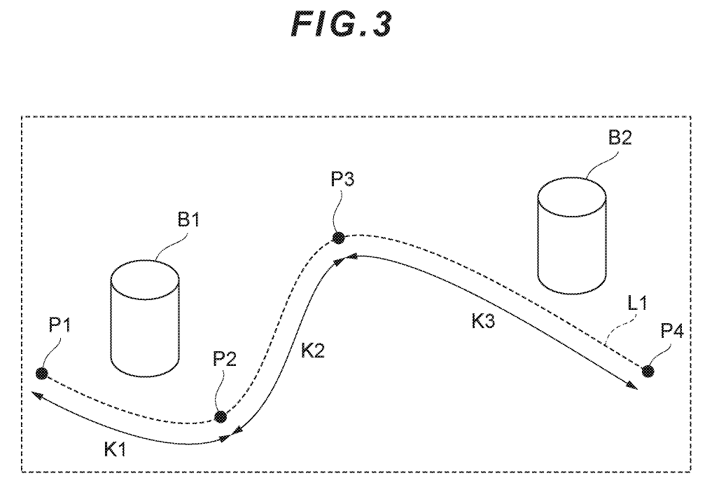

FIG. 3 is a diagram showing an exemplary operation of the robot 4. FIG. 3 shows the operation of the robot 4 as a path L1 of the distal end position of the robot 4. FIG. 3 also shows equipment B1 and equipment B2 as equipment installed in advance near the robot 4. For example, a user can specify passing points to set the operation of the robot 4. FIG. 3 shows point P1, point P2, point P3, and point P4 as the passing points. When the user sets the points P1 to P4 as the passing points for the robot 4 to operate through, interpolated points are set between the passing points and the path L1 is set to pass through the passing points P1 to P4. The pre-motion controller 31 controls the robot 4 to perform the preprogrammed operation to move along the path L1, for example. The equipment B1 and B2 are installed in a manner where they avoid the movement of the robot 4 performed according to the preprogrammed operation along the path L1.

The preprogrammed operation includes a plurality of intervals (stages) as in FIG. 3. FIG. 3 shows an interval K1, an interval K2, and an interval K3 as exemplary intervals. The intervals are each set to correspond to a corresponding region between passing points set by the user. The present embodiment describes an example in which the intervals are divided to correspond to the passing points. However, the intervals are not limited to being divided to correspond to the passing points, as long as the preprogrammed operation is divided into a plurality of intervals. The number of intervals is not limited to any particular number, either.

The setter 32 is configured to set correspondence information to correspond to the preprogrammed operation that the pre-motion controller 31 controls the robot 4 to perform. In other words, the setter 32 can set the correspondence information corresponding to the preparatory operation of the robot 4 as a preliminary stage before the operation that the main controller 33, described below, controls the robot 4 to perform.

The correspondence information is information associating each of the intervals of the preprogrammed operation with reference information on sensed values that are output from the sensors 5 of the robot 4 that performs the preprogrammed operation. In other words, by using the correspondence information, each interval is associated with the information on the sensed values in correspondence with the preprogrammed operation of the robot 4 that the pre-motion controller 31 controls. Since the correspondence information corresponds to the preprogrammed operation of the robot 4 that the pre-motion controller 31 controls, the effect, on the sensed values, of the equipment and the like that are installed in advance near the robot 4 can be reflected.

The reference information on the sensed values is set using the sensed values that have been output from the sensors 5 during the operation through the intervals. In the present embodiment, the reference information includes thresholds that are set by adding a margin (a predetermined value) to the maximum values of the sensed values that have been output from the sensor 5 during the operation through the intervals. The setter 32 sets the thresholds interval by interval.

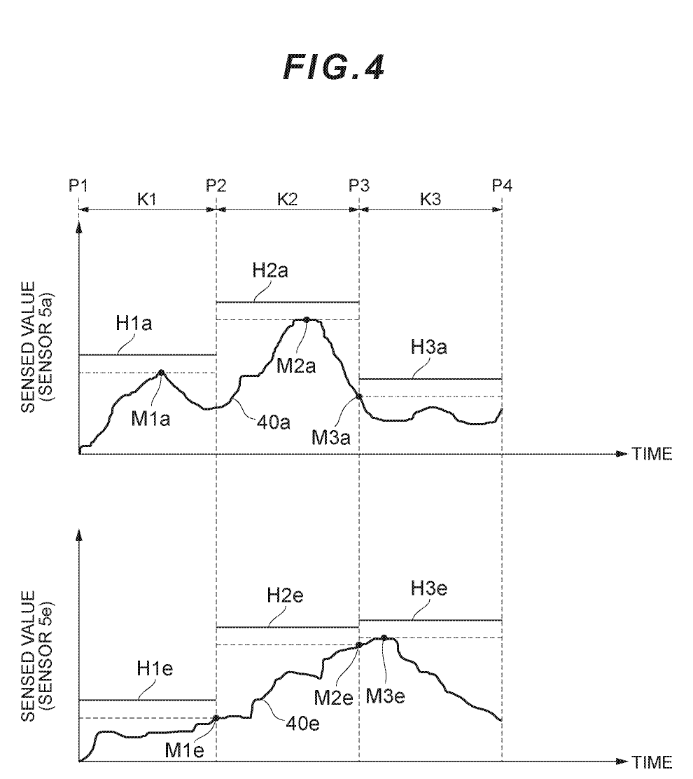

FIG. 4 is a diagram showing an example of changes in the sensed values when the pre-motion controller 31 controls the robot 4 to perform the preprogrammed operation. FIG. 4 shows changes in the sensed values corresponding to the sensor 5a and the sensor 5e, using a line 40a and a line 40e. In FIG. 4, the vertical axes indicate the sensed values, and the horizontal axes indicate time. The horizontal axes are also associated with points P1 to P4 serving as the passing points and intervals K1 to K3 serving as the intervals.

As shown by the lines 40a and 40e in FIG. 4, the sensed values change with the operation of the robot 4 moving from point P1 to point P4. For example, the sensed values vary with changes in the relative positional relationship between the sensors 5 and the nearby equipment and the like due to the operation of the robot 4. The setter 32 successively acquires the sensed values from the respective sensors 5 in correspondence with the preprogrammed operation that the pre-motion controller 31 controls the robot 4 to perform, and obtains changes of the respective sensed values like those represented by the lines 40a and 40e.

The setter 32 then identifies the maximum values of the sensed values corresponding to each interval. In the example of FIG. 4, for the sensed value of the sensor 5a (represented by the line 40a), the maximum value in the interval K1 is identified to be a value M1a, the maximum value in the interval K2 a value M2a, and the maximum value in the interval K3 a value M3a. For the sensed value of the sensor 5e (represented by the line 40e), the maximum value in the interval K1 is identified to be a value M1e, the maximum value in the interval K2 a value M2e, and the maximum value in the interval K3 a value M3e.

The setter 32 then sets thresholds by adding a margin to the maximum values interval by interval. For example, for the sensed value of the sensor 5a (represented by the line 40a), the threshold in the interval K1 is identified to be a value H1a, the threshold in the interval K2 a value H2a, and the threshold in the interval K3 a value H3a. For the sensed value of the sensor 5e (represented by the line 40e), the threshold in the interval K1 is identified to be a value H1e, the threshold in the interval K2 a value H2e, and the threshold in the interval K3 a value H3e.

In such a manner, the thresholds based on the maximum values are set interval by interval in correspondence with the preprogrammed operation. Thresholds are also similarly set for the sensors 5 other than the sensors 5a and 5e.

The setter 32 thus associates the intervals with the thresholds in correspondence with the preprogrammed operation, and sets the result as the correspondence information. The setter 32 sets the correspondence information by associating the effect of the equipment and the like with each sensor 5.

The robot 4 can take various postures depending on the preprogrammed operation. In some postures of the robot 4, for example, the positional relationship between one sensor 5 and another may become so close that the electric field generated by one sensor 5 can affect another. Since the correspondence information associates the intervals and the threshold of each sensor 5 in correspondence with the preprogrammed operation, such effects between sensors 5 are also reflected.

The main controller 33 controls the robot 4 to perform a preprogrammed operation after the correspondence information has been set. The preprogrammed operation may be the same as the operation that the pre-motion controller 31 controls the robot 4 to perform. Unlike the pre-motion controller 31, the main controller 33 controls the robot 4 to perform the preprogrammed operation in a state where an object such as a human worker enters (is allowed to enter) the vicinity of the robot 4. In other words, the main controller 33 controls the robot 4 to perform the preprogrammed operation in a state where an object other than the equipment and the like installed in advance near the robot can be present near the robot 4. For example, the main controller 33 operates the robot 4 in situations where the robot 4 and a human worker work collaboratively while sharing the same space. The preprogrammed operation that the main controller 33 controls the robot 4 to perform can be said to be an actual operation.

The main controller 33 successively acquires the sensed values from the sensors 5 when the robot 4 is performing the preprogrammed operation, and performs a stop or deceleration control of the robot 4, as necessary. The stop control is a control to stop the operation of the robot 4. The deceleration control is a control to reduce the operation speed of the robot 4. The present embodiment deals with a case of performing the stop control, which is not restrictive herein. Specifically, when the sensed values that have been output from the sensors 5 are compared with the reference information (thresholds) on the sensed values, associated with the intervals, if any of the sensed values in an interval reaches or exceeds its threshold corresponding to the interval, the main controller 33 is configured to perform the stop control.

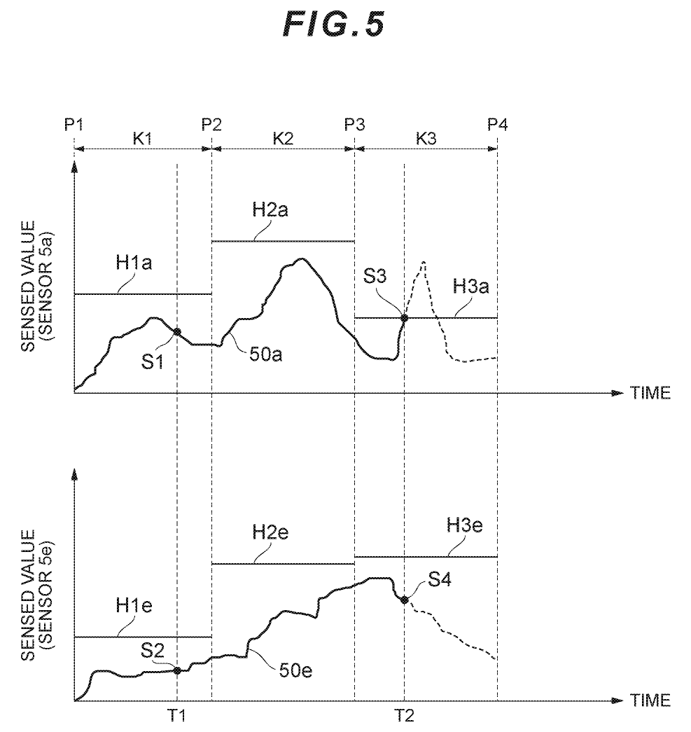

FIG. 5 is a diagram showing exemplary changes in the sensed values when the main controller 33 controls the robot 4 to perform the preprogrammed operation. FIG. 5 shows changes in the sensed values of the sensors 5a and 5e as an example of the sensors 5, showing the changes in the sensed values represented by lines 50a and 50e. In FIG. 5, like FIG. 4, the vertical axes indicate the sensed values, and the horizontal axes indicate time, with which points P1 to P4 serving as the passing points and intervals K1 to K3 serving as the intervals are associated. FIG. 5 also shows the thresholds in the respective intervals as with FIG. 4.

In the example of FIG. 5, at time T1 when the robot 4 is operating, the main controller 33 acquires a sensed value S1 from the sensor 5a and a sensed value S2 from the sensor 5e. The main controller 33 identifies the interval corresponding to the operation of the robot 4 in response to the timing of acquisition of the sensed values. For example, at time T1, the robot 4 is identified to be operating in the interval K1. The main controller 33 then compares the sensed value S1 of the sensor 5a with the threshold for the sensor 5a corresponding to the interval K1 (i.e., value H1a). Since the sensor S1 is less than the value H1a, the main controller 33 controls the robot 4 to continue operation. The main controller 33 also compares the sensed value S2 of the sensor 5e with the threshold for the sensor 5e corresponding to the interval K1 (i.e., value H1e). Since the sensed value S2 is less than the value H1e, the main controller 33 controls the robot 4 to continue operation. The main controller 33 also makes similar determinations for the sensors 5 other than the sensors 5a and 5e.

At time T2 when the robot 4 is operating, the main controller 33 acquires a sensed value S3 from the sensor 5a and a sensed value S4 from the sensor 5e. The setter 32 then identifies that the robot 4, at time T2, is operating in the interval K3. The main controller 33 compares the sensed value S3 of the sensor 5a with the threshold for the sensor 5a corresponding to the interval K3 (value H3a). Since the sensed value S3 is greater than or equal to the value H3a, the main controller 33 performs the stop control on the robot 4. The sensed value S4 of the sensor 5e is less than the threshold for the sensor 5e corresponding to the interval K3 (value H3e). The main controller 33 also makes similar determinations for the sensors 5 other than the sensors 5a and 5e. If any one of the sensed values of the plurality of sensors 5 reaches or exceeds its threshold, the main controller 33 thus performs the stop control on the robot 4.

In the foregoing example, the intervals are described to be identified based on the timing (time) of acquisition of the sensed values. However, the interval identification method is not limited to any particular method. For example, since the main controller 33 controls the operation of the robot 4, the main controller 33 can recognize the interval (current state) where the robot 4 is operating. The main controller 33 may therefore refer to the thresholds corresponding to the interval where the robot 4 under the operation control is operating, and perform the stop control or the like. In such a case, the changes in the sensed values shown in FIGS. 4 and 5 may be expressed with the horizontal axis indicating the position of the robot 4 on the operation path (for example, the end position of the robot 4).

The main controller 33 may, after performing the stop control on the robot 4, cancel the executed stop control and control the robot 4 to resume operation if all sensed values of the plurality of sensors 5 become less than their thresholds.

When the main controller 33 performs the stop control, the notifier 34 issues notification. The notifier 34 issues a notification that the sensed value of at least one sensor 5 reaches or exceeds its threshold and the stop control is thus performed. For example, the notifier 34 issues the notification by display or sound. For example, if the robot 4 is equipped with an indication lamp, the notifier 34 turns on the indication lamp for notification.

### Processing Flow

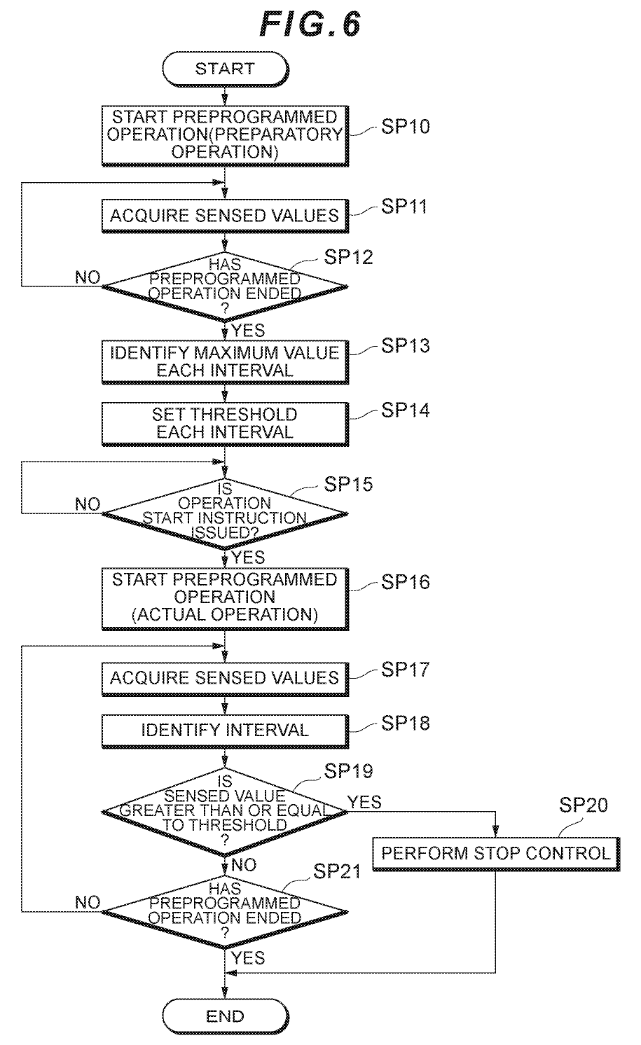

FIG. 6 is a flowchart showing an exemplary processing flow of the robot control apparatus 6 according to the present embodiment. The processing of the following steps is performed in response to the user's start instruction, for example. The order and contents of the following steps can be modified where appropriate.

### Step SP10

The pre-motion controller 31 controls the robot 4 to start a preprogrammed operation (as a preparatory operation) in the state where no objects enter the vicinity of the robot 4. The processing procedure proceeds to step SP11.

### Step SP11

The setter 32 acquires the sensed values that have been output from the sensors 5. Here, the setter 32 acquires the sensed values from the respective sensors 5. The processing procedure proceeds to step SP12.

### Step SP12

The setter 32 determines whether the preprogrammed operation has ended. If the preprogrammed operation has not ended, the processing procedure returns to step SP11 to continue the preprogrammed processing. Otherwise, the processing procedure proceeds to step SP13.

### Step SP13

The setter 32 identifies, for each of the sensor 5, a maximum value of the sensed value in each corresponding interval. The processing procedure proceeds to step SP14.

### Step SP14

The setter 32 sets thresholds for the respective sensors 5 interval by interval, by adding a margin to the maximum values. The setter 32 thereby associates the intervals with the thresholds in correspondence with the preprogrammed operation, and sets correspondence information. The processing procedure proceeds to step SP15.

In such a manner, preparations for the actual operation of the robot 4 by the main controller 33 are made through steps SP10 to SP14. In step SP15 and subsequent steps, the actual operation of the robot 4 is performed.

### Step SP15

The main controller 33 determines whether a start instruction for the preprogrammed operation is issued by the user. If the start instruction is issued, the processing procedure proceeds to step SP16. Otherwise, the processing procedure returns to step SP15 to perform the processing again. For example, the user issues the operation start instruction after the preparations for the collaborative work of the robot 4 and the human worker have been completed.

### Step SP16

The main controller 33 controls the robot 4 to start the preprogrammed operation (as an actual operation) in a state where objects are allowed to enter the vicinity of the robot 4. The processing procedure proceeds to step SP17.

### Step SP17

The main controller 33 acquires the sensed values from the respective sensors 5. The processing procedure proceeds to step SP18.

### Step SP18

The main controller 33 identifies the interval where the robot 4 is operating. The processing procedure proceeds to step SP19.

### Step SP19

The main controller 33 determines whether the sensed value of each sensor 5 is greater than or equal to its threshold corresponding to the identified interval. If none of the sensed values of the sensors 5 is greater than or equal to the threshold, the processing procedure proceeds to step SP21. If the sensed value of any one of the sensors 5 is greater than or equal to the threshold, the processing procedure proceeds to step SP20.

### Step SP20

The main controller 33 performs the stop control on the robot 4. The notifier 34 issues a notification that the stop control is performed. The processing procedure then ends.

### Step SP21

The main controller 33 determines whether the preprogrammed operation has ended. If the preprogrammed operation has not ended, the processing procedure returns to step SP17 to perform the processing procedure again. Otherwise, the processing procedure ends.

Although the stop control is described to be performed in step SP20 while the operation of the robot 4 is controlled in the manner described above. However, a deceleration control may be performed instead. In another embodiment, the main controller 33 may resume the operation of the robot 4 (performing stop cancellation or deceleration cancellation) if, for example, a resume instruction is received from the user or all sensed values of the plurality of sensors 5 fall below their thresholds after the stop control on the robot 4.

As described above, the pre-motion controller 31 sets the correspondence information by reflecting the effect of the equipment and the like installed near the robot 4. Using this correspondence information, the main controller 33 performs the stop control and the like of the robot 4. In situations where the robot 4 and a human worker work collaboratively, when the robot 4 and the human worker come close to each other, the main controller 33 is configured to stop or otherwise control the operation of the robot 4 using the correspondence information.

### Operation and Effects

As described above, in the present embodiment, the robot 4 including the arms equipped with the sensors 5 is controlled to perform a preprogrammed operation, and correspondence information is set by associating intervals with reference information on the sensed values. During an actual operation, the main controller 33 then uses the correspondence information to perform the stop or deceleration control of the robot 4. This can enable detection of presence of objects approaching the arms of the robot 4 using the sensors 5. Moreover, since the pre-motion controller 31 controls the robot 4 to perform the preprogrammed operation, the correspondence information can be set by taking into consideration the effect of the equipment and the like installed near the robot 4 (the environment surrounding the robot 4) on the sensed values depending on the preprogrammed operation (the posture of the robot 4). The preprogrammed operation changes the posture of the robot 4, and the sensors 5 can affect each other depending on the posture. However, the pre-motion controller 31 controls the robot 4 to perform the preprogrammed operation, thereby enabling setting of the correspondence information in consideration of the mutual effects of the sensors 5. In other words, the stop or deceleration control of the robot 4 can be performed in consideration of the environment surrounding the robot 4 as well as the mutual effects of the sensors 5. As a result, the operation of the robot 4 can be stopped or otherwise controlled by distinguishing whether the sensors 5 are detecting presence of the equipment and the like nearby or detecting presence of an object such as a human worker. In other words, the presence of objects approaching the arms of the robot 4 can be detected, and the accuracy of object detection by the sensors 5 can be improved. Moreover, since the reference information (thresholds) on the sensed values is set to correspond to the intervals, whether to perform the stop or deceleration control of the robot 4 can be determined interval by interval. In other words, the processing load for object detection can be reduced.

Furthermore, since the thresholds are set based on the maximum values of the sensed values during the operation through the intervals, the thresholds related to the stop or deceleration control can be set in consideration of situations where the sensed values peak in the respective intervals. As a result, for example, the presence of equipment installed in advance near the robot 4 and human workers approaching the robot 4 can be detected in an effectively distinguished manner. Since the thresholds are set interval by interval, the processing load can also be reduced.

### SECOND EMBODIMENT

Next, a second embodiment will be described.

The second embodiment deals with a case of correcting the operation of a robot 4, which is not restrictive herein. A description of the same aspects as those of the first embodiment will be omitted. The second embodiment may be combined with the first embodiment.

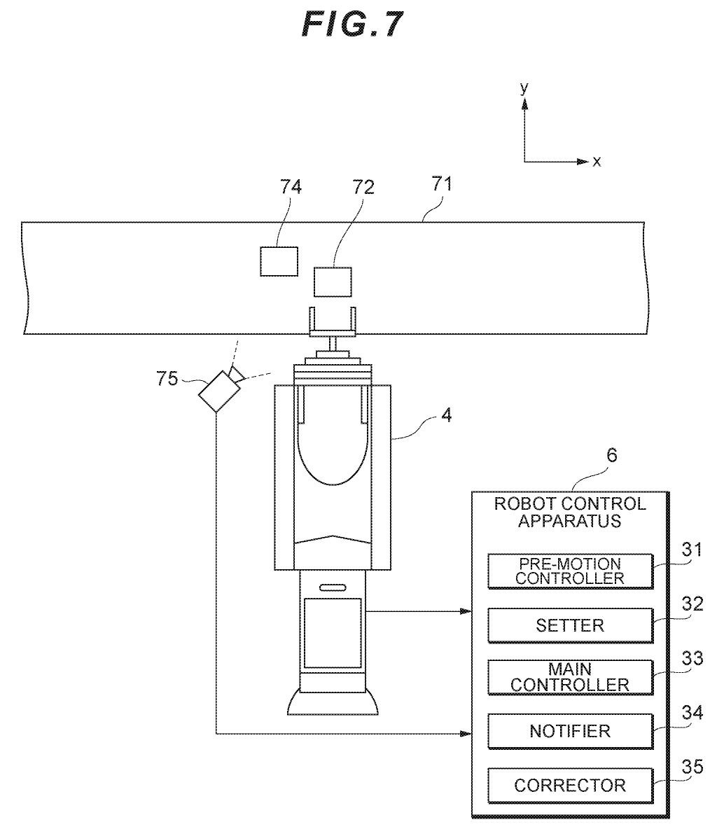

FIG. 7 is a diagram showing various exemplary functions implemented by a robot control apparatus 6 according to the present embodiment. The robot control apparatus 6 further includes a corrector 35.

The corrector 35 is configured to correct the operation of the robot 4 that is performing a preprogrammed operation. For example, as shown in FIG. 7, the preprogrammed operation may include an operation in which the robot 4 grips a workpiece that has been conveyed to a reference position 72 by a conveyor 71. Here, the workpiece on the conveyor 71 may be conveyed to a position 74 off the reference position 72. In such a case, to grip the workpiece, the operation of the robot 4 needs to be corrected from the reference position 72 to accommodate the position 74. For that purpose, the corrector 35 is configured to correct the operation so that the robot 4 can grip the workpiece at the position 74 instead of the reference position 72. For example, when the plane of the conveyor 71 is defined as an x-y plane, the x and y coordinates are corrected to correspond to the position 74. For example, the corrector 35 can measure the position of the workpiece using a camera 75, and correct the operation to that position. The operation correction can be said to be an operation shift control. The corrector 35 may refrain from correcting the operation if, for example, the positional deviation of the workpiece is within an allowable range.

If the preprogrammed operation is thus corrected, the positional relationship of the sensors 5 relative to nearby equipment and the like can change due to the correction. Correspondence information is thus set in consideration of changes in the operation of the robot 4 due to the correction.

As in the foregoing embodiment, a pre-motion controller 31 controls the robot 4 to perform the preprogrammed operation. The corrector 35 makes possible corrections to the preprogrammed operation that the pre-motion controller 31 controls the robot 4 to perform. For example, the workpiece gripping position is corrected as shown in FIG. 7. Here, the pre-motion controller 31 controls the robot 4 to perform the preprogrammed operation a plurality of times, and the corrector 35 makes a correction under a different correction pattern each time. In the present embodiment, the number of correction patterns is α where α is an integer greater than or equal to 2. In other words, the robot 4 is operated α times based on the preprogrammed operation, under the respective α correction patterns of the corrector 35. For each of the α correction patterns, the conveyor 71 may convey a workpiece to a shifted position and the robot 4 may be operated accordingly. Alternatively, for each of the α correction patterns, corrections may be made without conveying a workpiece but assuming that a workpiece is located at a shifted position, and the robot 4 may be operated accordingly. The α correction patterns may include a pattern without correction.

A setter 32 is configured to set correspondence information using the sensed values obtained when the robot 4 is operated α times. Specifically, the setter 32 is configured to determine, as maximum values, the maximum values of the sensed values in the intervals when the robot 4 is operated under each of the α correction patterns made by the corrector 35. The setter 32 then sets the thresholds in the respective intervals by adding a margin to the corresponding maximum values. For example, when the robot 4 is operated α times, α change patterns of the sensed value are obtained from a single sensor 5 and a single interval. With the maximum sensed value, in the α change patterns of the sensed value, considered as a maximum value, the setter 32 adds the margin to the maximum value and sets the sum as the threshold corresponding to that sensor 5 and that interval. The thresholds for the respective sensors 5 corresponding to the respective intervals are thus set in correspondence with the α times of operation of the robot 4. By setting the thresholds in such a manner, the correspondence information (thresholds) is set in consideration of the operation correction patterns where the robot 4 comes closest to the equipment installed in advance, for example.

A main controller 33 then controls the robot 4 to perform the preprogrammed operation, and performs a stop operation of the robot 4 using the set correspondence information. Specifically, the main controller 33 performs the stop control when a sensed value reaches or exceeds its threshold.

When the main controller 33 controls the robot 4 to perform the preprogrammed operation, the corrector 35 performs operation correction. For example, while the main controller 33 controls the robot 4 to perform the preprogrammed operation, the corrector 35 makes corrections so that the position to grip the workpiece is corrected from the reference position 72 to the position 74. For example, the corrector 35 recognizes, using the camera, the position of the workpiece that is actually conveyed by the conveyor 71 75, and corrects the operation of the robot 4 to that position. Since the correspondence information is set to correspond to various correction patterns, the stop control can be performed using appropriate thresholds even if the corrector 35 makes corrections during the operation controlled by the main controller 33.

In the foregoing example, the correspondence information is described to be set without distinguishing the α correction patterns. However, the correspondence information may be set by distinguishing the α correction patterns.

Specifically, the pre-motion controller 31 and the corrector 35 control the robot 4 to perform operations α times based on the preprogrammed operation, under the respective α correction patterns in the same manner as described above. Here, the α correction patterns are classified into a plurality of groups. For example, the α correction patterns are classified into a plurality of groups depending on the operation direction related to the correction (hereinafter, referred to as a "correction direction") or the amount of operation related to the correction (hereinafter, referred to as a "correction amount"). Specifically, the α correction patterns are classified into a plurality of groups so that correction patterns with close (similar) correction directions or correction amounts belong to one group. The correction directions and the correction amounts are identified, for example, based on the tool position (TCP position), the orientation angles of the tool (roll, pitch, and yaw angles), and the axial angles of the respective joints.

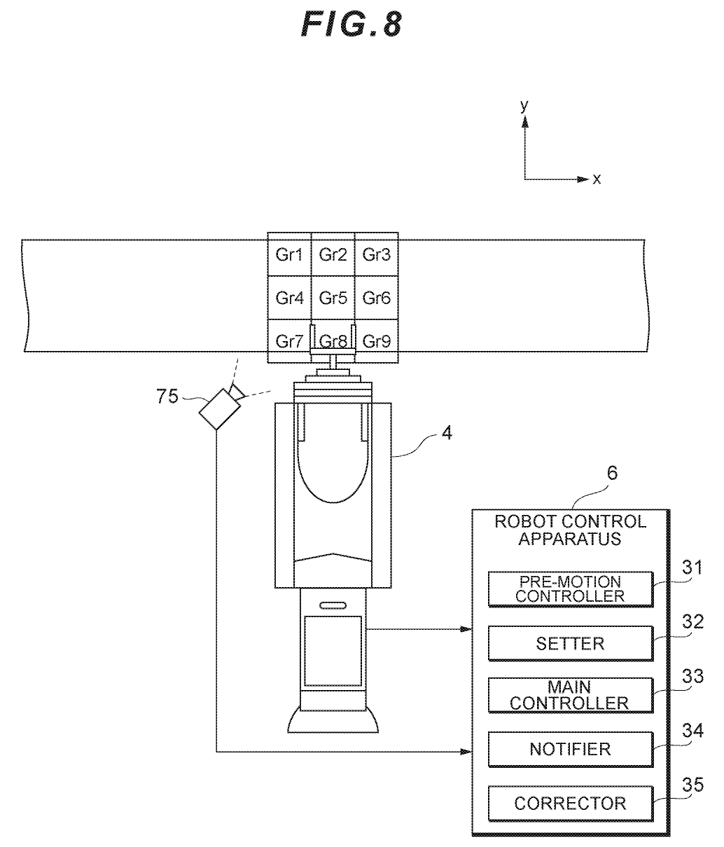

FIG. 8 is a diagram showing an exemplary group classification corresponding to a plurality of correction patterns. When the conveyor 71 conveys a workpiece, the position of the workpiece may deviate within the x-y plane. For various workpiece positions, a plurality of (for example, α) correction patterns can be assumed in the x- and y-axis directions. In the embodiment illustrated in FIG. 8, there are nine groups Gr1 to Gr9. The group that includes the reference position 72 is group Gr5. The other groups are set to surround the group Gr5 at the center. The α correction patterns are classified into the nine groups in the present embodiment. Each group preferably includes more than one correction pattern.

The setter 32 identifies the maximum values of the sensed values in respective intervals when the robot 4 is operated under the correction patterns included in a group as maximum values. In other words, a maximum value is identified for each interval and each group. The setter 32 then sets thresholds corresponding to the interval and group by adding a margin to the corresponding maximum values. In such a manner, the thresholds for the respective sensors 5 corresponding to the intervals and groups are set.

The main controller 33 then controls the robot 4 to perform the preprogrammed operation, and performs the stop control of the robot 4 using the set correspondence information. While the main controller 33 controls the robot 4 to perform the preprogrammed operation, the corrector 35 makes operation corrections. The main controller 33 thus performs the stop control using the thresholds of the group corresponding to the corrections made by the corrector 35. Specifically, the main controller 33 performs the stop control when a sensed value reaches or exceeds its threshold. The main controller 33 thus performs determination processing using the thresholds corresponding to the sensors 5, intervals, and groups, and controls operation of the robot 4.

For example, if the corrector 35 makes a correction corresponding to the group Gr1 while the main controller 33 controls the robot 4 to perform the preprogrammed operation, the stop control of the robot 4 is performed using the thresholds corresponding to the group Gr1. When the robot 4 and an object come close to each other, the robot 4 can thus be stopped or otherwise controlled using appropriate thresholds in consideration of the correction content as well.

### Operation and Effects

As described above, according to the present embodiment, the setter 32 sets the thresholds based on the maximum values in the intervals when the robot 4 is operated under each of the correction patterns. As a result, the thresholds related to the stop or deceleration control can be set in consideration of the states where the sensed values peak depending on the correction patterns. In other words, the operation of the robot 4 can be stopped or otherwise controlled by distinguishing whether the sensors 5 are detecting the presence of nearby equipment and the like or detecting presence of objects such as human workers, with corrections taken into consideration. The stop control and the like of the robot 4 can thus be performed to correspond to various operation patterns.

If the correction patterns are classified into a plurality of groups, the setter 32 sets thresholds corresponding to the intervals and groups. More appropriate thresholds can thereby be set depending on the correction patterns, and the accuracy of object detection improves.

### THIRD EMBODIMENT

Next, a third embodiment will be described.

The third embodiment deals with a case where an output delay in sensors 5 is taken into consideration, which is not restrictive herein. A description of to the same aspects as those of the first and second embodiments will be omitted. The third embodiment can also be combined with at least one of the first and second embodiments.

Components like A/D converters, low-pass filters, and the like that constitute the sensors 5 can cause an output delay. For example, A/D converters are provided to output digital signals from the sensors 5. For example, low-pass filters are provided to reduce noise in the sensors 5. The sensors 5 can thus cause a slight time delay (output delay) before the effects of the capacitances created between the sensors 5 and objects are reflected on the sensed values. Output delay may also occur in the sensors 5 due to components other than the A/D converters. For example, if the operation speed of a robot 4 differs between a preparatory operation of the robot 4 by a pre-motion controller 31 when setting the correspondence information and an actual operation of the robot 4 by a main controller 33 that performs operation control using the correspondence information, the output delay in the sensors 5 may have an effect on the operation control. For example, if the preparatory operation of the robot 4 is performed at a low speed and the actual operation of the robot 4 is then performed at an operation speed higher than the low speed, the output delay in the sensors 5 may have an effect on the operation control of the main controller 33. In the present embodiment, the main controller 33 thus controls the operation of the robot 4 in consideration of the output delay in the sensors 5. Time related to the operation delay of the sensor 5 is referred to herein as a delay time.

Specifically, a main controller 33 identifies the interval corresponding to sensed values in consideration of the output delay in the sensors 5. For example, the main controller 33 identifies the interval corresponding to the operation of the robot 4 the delay time before the timing when the sensed values are acquired (a timing when the sensed values are output from the sensors 5). For example, the interval corresponding to the operation of the robot 4 the delay time before is desirably identified in consideration of the operation speed of the robot 4. In other words, the sensed values and the intervals are associated with each other in consideration of the delay time. As a result, for example, even if the timing when the sensed values are acquired corresponds to the interval K2, the operation of the robot 4 corresponding to the acquired sensed values may be identified as corresponding to the interval K1. The main controller 33 then compares the sensed values with the thresholds in the interval that is identified in consideration of the output delay, and performs stop control.

For example, due to the effect of low-pass filters, changes in the sensed values may fail to keep up and the sensed values may remain low if the operation speed of the robot 4 is high. When acquiring sensed values, the main controller 33 may therefore correct the sensed values depending on the operation speed of the robot 4. For example, the correction is made so that the higher the operation speed of the robot 4, the greater the sensed values. In other words, the sensed values may be corrected based on the operation speed so that decreases in the sensed values corresponding to the operation speed of the robot 4 are reduced.

The method for taking into consideration the output delay in the sensors 5 is not limited to the foregoing. For example, the output delay may be reflected on the correspondence information. More specifically, the setter 32 sets correspondence information in consideration of the output delay in the sensors 5, and the main controller 33 performs the stop control using the set correspondence information.

Specifically, the setter 32 acquires changes in the sensed values such as shown in FIG. 4 from the sensors 5. Note that the changes in the sensed values shown in FIG. 4 are such that the sensed values are associated with the operation (the interval) of the robot 4 at the timing when the sensed values are acquired (the timing when the sensed values are output). For example, when the line 40a indicating changes in the sensed value corresponding to the sensor 5a in FIG. 4 is acquired, the setter 32 thus makes corrections by shifting (advancing or delaying) the entire line 40a by a delay time estimated to occur during the actual operation. The sensed values included in the line 40a are thereby associated with the intervals in consideration of the output delay. After the correction of the line 40a in consideration of the output delay, the setter 32 identifies the maximum values of the sensed values interval by interval, and sets thresholds in the respective intervals.

The foregoing example has dealt with the case where the time is shifted by as much as the delay time. Alternatively, low-pass filter processing may be performed on the changes in the sensed value (line 40a). Specifically, when the changes in the sensed value (line 40a) as shown in FIG. 4 are obtained, for example, the setter 32 applies low-pass filter processing to the data on the changes in the sensed value. The behavior during the actual operation can thereby be simulated from the changes in the sensed value (line 40a) such as shown in FIG. 4. After the low-pass filter processing has been performed on the line 40a, the setter 32 identifies the maximum values of the sensed value interval by interval, and sets thresholds in the respective intervals. Since the use of the low-pass filter can reflect a decrease in gain, thresholds may be set for each operation speed of the robot 4, for example.

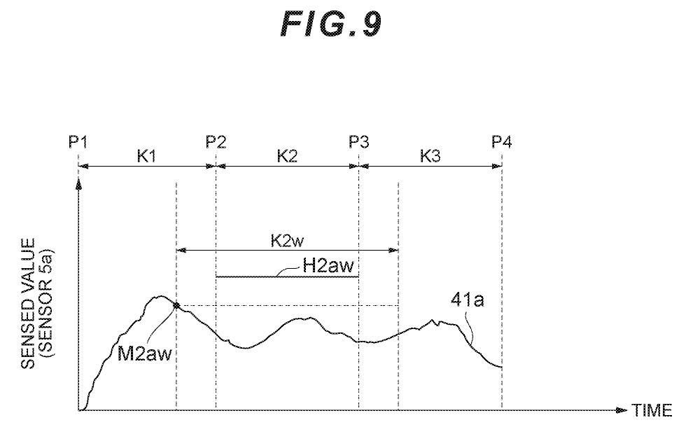

The setter 32 may set correspondence information corresponding to the output delay by using other methods. FIG. 9 is a diagram showing an exemplary setting of the correspondence information corresponding to an output delay. For example, the setter 32 obtains a line 41a representing changes in the sensed value corresponding to the sensor 5a. The line 41a represents exemplary changes different from those of the line 40a in FIG. 4. The setter 32 then identifies a maximum value and sets a threshold corresponding to the interval K2 based on the changes in the sensed value for the interval K2w that is an interval wider than the interval K2. For example, the interval K2w is preferably wider than the interval K2 in the earlier direction (corresponding to operation of the robot 4 before the interval K2) and wider than the interval K2 in the later direction (corresponding to operation of the robot 4 after the interval K2). If the robot 4 reciprocates, delay may occur in different directions on the way forward and back.

The interval K2w wider than the interval K2 in both directions is therefore preferably used. Alternatively, the interval K2w may be wider than the interval K2 in one direction to correspond to the way forward or back. For example, the setter 32 sets the maximum value of the sensed value (represented by the line 41a) in the interval K2w as a value M2aw. The setter 32 then adds a margin to the value M2aw to calculate a value H2aw, and sets the value H2aw as the threshold in the interval K2. Thresholds are similarly set in other intervals.

In such a manner, the setter 32 sets correspondence information in consideration of the output delay in the sensors 5, and the main controller 33 performs the stop control and the like using the set correspondence information.

The foregoing example has dealt with a case where the operation speed differs between the preparatory operation of the robot 4 by the pre-motion controller 31 and the actual operation of the robot 4 by the main controller 33. However, the operation speed may be assumed to be the same during the preparatory operation and during the actual operation. In such a case, to reduce the effect of the output delay, the preparatory operation may be performed at low operation speed (speed lower than a predetermined speed). Moreover, in the foregoing example, the output delay in the sensors 5 is described to possibly have an effect on the operation control if the operation speed differs between the preparatory operation of the robot 4 by the pre-motion controller 31 and the actual operation of the robot 4 by the main controller 33. However, the output delay in the sensors 5 may also have an effect in other situations. For example, if the robot 4 performs operation including a forward pass and a return pass along the same path and the correspondence information is set as described above based on the operation on only one of the forward and return passes, the output delay in the sensors 5 may have an effect on the operation control. When the robot 4 is controlled to perform operation including forward and return passes, both correspondence information corresponding to the forward pass and correspondence information corresponding to the return pass are preferably set. While the output delay in the sensors 5 may thus have an effect in various situations, controlling the operation of the robot 4 as described above reduces the effect of the output delay in the sensors 5.

### Operation and Effects

As described above, in the present embodiment, the main controller 33 identifies the interval corresponding to the sensed values in consideration of the output delay in the sensors 5. When an output delay occurs in the sensors 5, the output delay can thus be accommodated. In other words, the accuracy related to object detection can be improved in consideration of the output delay in the sensors 5.

The setter 32 also sets correspondence information in consideration of the output delay in the sensors 5. When an output delay occurs in the sensors 5, the output delay can thus be accommodated. In other words, the accuracy related to object detection can be improved in consideration of the output delay in the sensors 5.

### MODIFICATIONS

The present invention is not limited to the foregoing embodiments. Any modifications achievable by those skilled in the art through appropriate design changes to the foregoing specific examples are also included in the scope of the present invention as long as the modifications have the features of the present invention. The components of the foregoing embodiments and the components in the modifications described below can be combined as far as technically feasible. Such combinations are also included in the scope of the present invention as long as the combinations have the features of the present invention.

For example, in the foregoing embodiments, the robot 4 and the robot control apparatus 6 are described to be provided as separate members. However, the robot control apparatus 6 may be built into the robot 4.

In the foregoing embodiments, the reference information on the sensed values is described to be thresholds that are set by adding a margin to the maximum values of the sensed values in the intervals. However, the reference information on the sensed values is not limited to the foregoing. For example, the reference information may be thresholds that are set by adding a margin to averages or medians of the sensed values obtained corresponding to the intervals. The reference information may include the maximum values of the sensed values obtained corresponding to the intervals as the thresholds. The reference information is thus not limited as long as set based on the sensed values that are output from the sensors 5 during the operation controlled by the pre-motion controller 31.

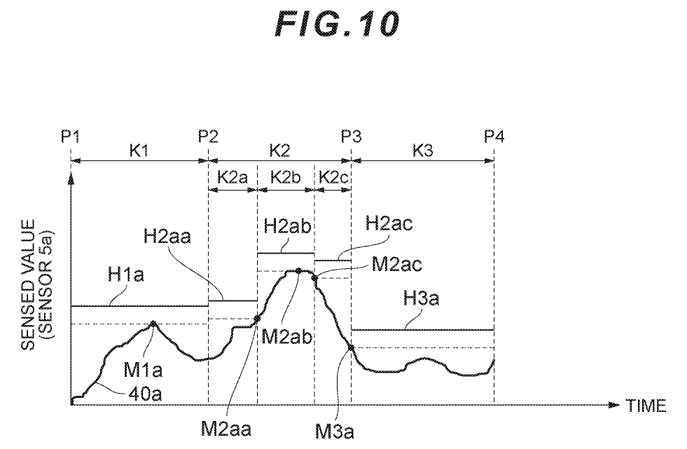

In the foregoing embodiment, the setter 32 is described to set the correspondence information by setting the thresholds corresponding to the plurality of intervals of the preprogrammed operation. However, the setter 32 may have an interval dividing function. Specifically, the setter 32 may subdivide an interval that is set between passing points into smaller intervals. The setter 32 can subdivide an interval based on at least one of the following: the moving distance of the robot 4, the time needed for the operation of the robot 4, and changes in the sensed values. For example, if the moving distance of the robot 4 in an interval is greater than or equal to a predetermined value, the setter 32 subdivides the interval. FIG. 10 shows an exemplary interval subdivision method. Like FIG. 4, FIG. 10 shows changes in the sensed value of the sensor 5a as a line 40a. For example, if the moving distance of the robot 4 in the interval K2 is greater than or equal to a predetermined value, the setter 32 subdivides the interval K2 into an interval K2a, an interval K2b, and an interval K2c. For example, the setter 32 subdivides an interval into a preset number of intervals. The setter 32 then sets correspondence information for each of the subdivided intervals. For example, the setter 32 sets thresholds (values H1a and H3a) for the intervals K1 and K3 in the same manner as in the foregoing embodiments. The setter 32 also identifies the maximum value (a value M2aa) in the interval K2a, the maximum value (a value M2ab) in the interval K2b, and the maximum value (a value M2ac) in the interval K2c. The setter 32 then adds a margin to the respective maximum values to calculate a threshold (a value H2aa) in the interval K2a, a threshold (a value H2ab) in the interval K2b, and a threshold (a value H2ac) in the interval K2c, and sets the correspondence information. The main controller 33 then performs a stop control of the robot 4 using the set correspondence information.

The setter 32 may subdivide an interval if the time needed for the operation of the robot 4 in the interval is greater than or equal to a predetermined value. Alternatively, the setter 32 may subdivide an interval if the sensed value in the interval changes by a predetermined value or more or if the interval includes more than one local maximum.

As described above, the setter 32 may subdivide an interval based on at least one of the moving distance of the robot 4, the time needed for the operation of the robot 4, and changes in the sensed value, and may set correspondence information for each of the subdivided intervals. More appropriate thresholds can thereby be set, and the accuracy of object detection improves.

What is claimed is:

1. A robot system comprising:
a robot including a plurality of arms;
a plurality of noncontact sensors disposed in the arms and configured to detect presence of an object; and
a robot control apparatus programmed to control operation of the robot based on sensed values that are output from the noncontact sensors, wherein:
the robot control apparatus includes
a memory in which a program is stored, and
a processor programmed to execute the program stored in the memory; and
the processor is programmed
to control the robot to perform a preprogrammed operation,
to set correspondence information by associating each of intervals of the preprogrammed operation with reference information on the sensed values that are output from the noncontact sensors due to the preprogrammed operation, and
to control, after the correspondence information has been set, the robot to perform the preprogrammed operation, and to perform a stop control or a deceleration control of the robot by comparing the sensed values that are output from the noncontact sensors with the reference information on the sensed values related to the intervals.

2. The robot system according to claim 1, wherein the processor is programmed
to set thresholds corresponding to the intervals as the reference information by adding a margin to maximum values of the sensed values that are output from the noncontact sensors in the intervals during operation, and
to perform, if one of the sensed values corresponding to one of the intervals reaches or exceeds the threshold corresponding to the interval, the stop control or the deceleration control.

3. The robot system according to claim 2, wherein the processor is programmed
to correct the operation of the robot performing the preprogrammed operation, and
to set the thresholds corresponding to the intervals with the maximum values of the sensed values in the intervals when the robot is operated under each of a plurality of correction patterns as the maximum values.

4. The robot system according to claim 3, wherein:
the correction patterns are classified into a plurality of groups; and
the processor is programmed
to set the thresholds corresponding to the intervals and the groups with the maximum values
of the sensed values in the intervals when the robot is operated under each of the correction patterns included in the groups as the maximum values, and
to perform the stop control or the deceleration control on the operation of the robot using the thresholds of the groups corresponding to the correction patterns.

5. The robot system according to claim 1, wherein the processor is programmed to identify an interval corresponding to the sensed values of the noncontact sensors in consideration of an output delay in the sensed values, and to perform the stop control or the deceleration control by comparing the sensed values with the reference information in the identified interval.

6. The robot system according to claim 1, wherein the processor is programmed
to set the correspondence information in consideration of an output delay in the sensed values of the noncontact sensors, and
to perform the stop control or the deceleration control using the set correspondence information.

7. The robot system according to claim 2, wherein the processor is programmed to identify an interval corresponding to the sensed values of the noncontact sensors in consideration of an output delay in the sensed values, and to perform the stop control or the deceleration control by comparing the sensed values with the reference information in the identified interval.

8. The robot system according to claim 2, wherein the processor is programmed
to set the correspondence information in consideration of an output delay in the sensed values of the noncontact sensors, and
to perform the stop control or the deceleration control using the set correspondence information.
